(19) United States
(12) Patent Application Publication
(10) Pub. No.: US 2007/0231672 A1
(43) Pub. Date: Oct. 4, 2007

(54) CELL FOR FUEL CELL, PRODUCTION METHOD FOR THE SAME AND POLYMER ELECTROLYTE FUEL CELL

(75) Inventors: Koushin Tanaka, Shizuoka-shi (JP); Toshiyasu Suzuki, Hamamatsu-shi (JP)

Correspondence Address: WOOD, HERRON & EVANS, LLP, 2700 CAREW TOWER, 441 VINE STREET, CINCINNATI, OH, 45202, US

(73) Assignee: TOMOEGAWA CO., LTD., Tokyo (JP)

(21) Appl. No.: 11/693,335

(22) Filed: Mar. 29, 2007

(30) Foreign Application Priority Data
Mar. 31, 2006 (JP) 2006-097759

(51) Int. Cl. H01M 4/86; H01M 4/94

(52) U.S. Cl. 429/42; 429/44; 502/101

(57) ABSTRACT

One object of the present invention is to provide a cell, a production method for a fuel cell to produce a polymer electrolyte fuel cell having high electric generating performance, the present invention provides a cell for a fuel cell comprising an electrolyte membrane, conductive porous members in a sheet shape or a plate shape which are laminated so as to sandwich the electrolyte membrane, and contains an ion catalyst at least the electrolyte membrane side, and separators in a sheet shape which are laminated so as to sandwich the electrolyte membrane and conductive porous members and comprises a supplying opening and a discharging opening for fluid, wherein at least one of the conductive porous members is a conductive fiber-containing porous member comprising a binder resin and conductive fibers, and the conductive fiber-containing porous member comprises an orientation layer in which conductive fibers are orientated along a flow direction of the fluid.

### BACKGROUND OF THE INVENTION

1. Field of the Invention

The present invention relates to a cell used for a fuel cell, a production method for the cell, and a polymer electrolyte fuel cell comprising the cell for a fuel cell.

Priority is claimed on Japanese Patent Application No. 2006-97759, filed Mar. 31, 2006, the content of which is incorporated herein by reference.

2. Description of the Related Art

A fuel cell is an electric generating system in which fuel containing hydrogen and an oxidizing agent containing oxygen are continuously supplied, and chemical energy obtained by reacting the fuel with the oxidizing agent is produced as electrical power. Various kinds of fuel cell have been known, in particular, a polymer electrolyte fuel cell including an electrolyte membrane made of a solid polymer has been widely used.

The electrolyte polymer fuel cell includes cells for a fuel cell. For example, a fuel cell is well-known, which includes a first separator including a supplying opening and a discharging opening for an oxidizing agent, a first conductive porous member for dispersing the oxidizing agent, an electrolyte membrane having ion conductivity, a second conductive porous member for dispersing fuel, and a second separator including a supplying opening and a discharging opening for the fuel. The first conductive porous member, for example, includes a first catalyst layer which is provided at the electrolyte membrane side and contains an ion catalyst for generating oxygen ions from the oxidizing agent, and a first gas diffusion layer provided at the first separator side. In addition, the second conductive porous member, for example, includes a second catalyst layer which is provided at the electrolyte membrane side and contains an ion catalyst for generating hydrogen ions from the fuel, and a second gas diffusion layer provided at the second separator side.

The conductive porous member provided in a cell for a fuel cell is required to have high gas diffusion ability and conductivity in order to improve electric generating performance. For example, Japanese Unexamined Patent Application, First Publication No. 2005-294115 discloses a conductive porous member including carbon fibers, as the conductive porous member which achieves the object.

However, a polymer electrolyte fuel cell having a cell including the conductive porous member disclosed the in document does not have sufficient electric generating performance. For example, there is a case in which the voltage suddenly decreases when trying to increase the electric current density.

In consideration of the above-described problems, it is an object of the present invention to provide a cell for a fuel cell to produce a polymer electrolyte fuel cell having high electric generating performance, and a method for producing the cell. In addition, the present invention has another object to provide a polymer electrolyte fuel cell having high electric generating performance.

After the present inventors examined the reasons the fuel cell including the conductive porous membrane disclosed in Japanese Unexamined Patent Application, First Publication No. 2005-294115 does not have sufficient electric generating performance, they found that water generated by electric generation is not sufficiently discharged and stored in the conductive porous member, and the water prevents electrons and ions from moving. Then, as a result of conducting diligent research that focused on this problem, the present inventors invented the following cells for a fuel cell, the methods for producing the cell, and the polymer electrolyte fuel cell.

### SUMMARY OF THE INVENTION

In other words, the present invention provides a cell for a fuel cell comprising an electrolyte membrane, conductive porous members in a sheet shape or a plate shape which are laminated so as to sandwich the electrolyte membrane, and contains an ion catalyst at at least the electrolyte membrane side, and separators in a sheet shape which are laminated so as to sandwich the electrolyte membrane and conductive porous members and comprises a supplying opening and a discharging opening for fluid, wherein at least one of the conductive porous members is a conductive fiber-containing porous member comprising a binder resin and conductive fibers, and the conductive fiber-containing porous member comprises an orientation layer in which conductive fibers are orientated along a flow direction of the fluid.

In the cell for a fuel cell, it is preferable that the conductive fiber-containing porous member comprise a catalyst layer which is positioned at the electrolyte membrane side and contain an ion catalyst, conductive material, and a binder resin, and a gas diffusion layer which is positioned at the separator side and contains conductive material, and that the gas diffusion layer comprise the orientation layer.

In the cell for a fuel cell, it is preferable that the conductive fiber-containing porous member comprise a catalyst layer which is positioned at the electrolyte membrane side and contain an ion catalyst, conductive material, and a binder resin, and a gas diffusion layer which is positioned at the separator side and contain conductive material, and that the catalyst layer comprise the orientation layer.

In the cell for a fuel cell, it is also preferable that the orientation layer contain an ion catalyst.

In addition, the present invention provides a method for producing a cell for a fuel cell comprising forming conductive porous members in a sheet shape or a plate shape which contains an ion catalyst at least an electrolyte membrane side on both sides of the electrolyte membrane; and laminating separators in a sheet shape which comprises a fluid supplying opening and a discharging opening for fluid, wherein at least one of the conductive porous members is a conductive fiber-containing porous member comprising a conductive fiber-containing layer which is obtained by using a conductive fiber-containing slurry comprising conductive fibers, a binder resin, and dispersing medium and orientating the conductive fibers in one direction, and laminating the separators on the conductive fiber-containing porous member such that the conductive fibers in the conductive fiber-containing layer are oriented along a flow direction of the fluid.

In addition, the present invention provides a polymer electrolyte fuel cell comprising the cell for a fuel cell according to the above.

In the present invention, “laminating” means not only laminating directly a layer onto another layer but also laminating a layer on another layer via the other layer.

According to the cell for a fuel cell of the present invention, it is possible to obtain a polymer electrolyte fuel cell having high electric generating performance.

According to the method for producing a cell for a fuel cell, it is possible to produce a cell for a fuel cell which produces a fuel cell having high electric generating performance.

The polymer electrolyte fuel cell of the present invention has high electric generating performance.

### BRIEF DESCRIPTION OF THE DRAWINGS

FIG. 1 is a cross-sectional view showing a first embodiment of the cell for a fuel cell according to the present invention.

FIG. 2 is a plan view showing one embodiment of the separator.

FIG. 3 is a cross-sectional view showing a second embodiment of the cell for a fuel cell according to the present invention.

FIG. 4 is a cross-sectional view showing a third embodiment of the cell for a fuel cell according to the present invention.

FIG. 5 is a plan view showing another embodiment of the separator.

FIG. 6 is a plan view showing another embodiment of the separator.

FIG. 7 is a schematic view showing one embodiment of the fuel cell according to the present invention.

### DETAILED DESCRIPTION OF THE INVENTION

The present invention will be explained in more detail referring to the following embodiments.

### First Embodiment

The first embodiment of the cell for a fuel cell (abbreviated as “cell” below) of the present invention is explained below. In this embodiment, a conductive porous member includes a gas diffusion layer and a catalyst layer, and the gas diffusion layer includes an orientation layer.

FIG. 1 shows the cell of this embodiment. A cell 1a shown in FIG. 1 includes a first separator 10, a first conductive porous member 20a, an electrolyte membrane 30, a second conductive porous member 40a, and a second separator 50, and these are laminated. Specifically, the cell 1a includes the electrolyte membrane 30, the first and second conductive porous members 20a and 40a which are laminated so as to sandwich the electrolyte membrane 30, the first and second separators 10 and 50 which are laminated so as to sandwich the electrolyte membrane 30, and the first and second conductive porous members 20a and 40a.

Moreover, in general, the side in which an oxidizing agent is supplied is a cathode side, and the side in which fuel is supplied is an anode side.

### [First Separator]

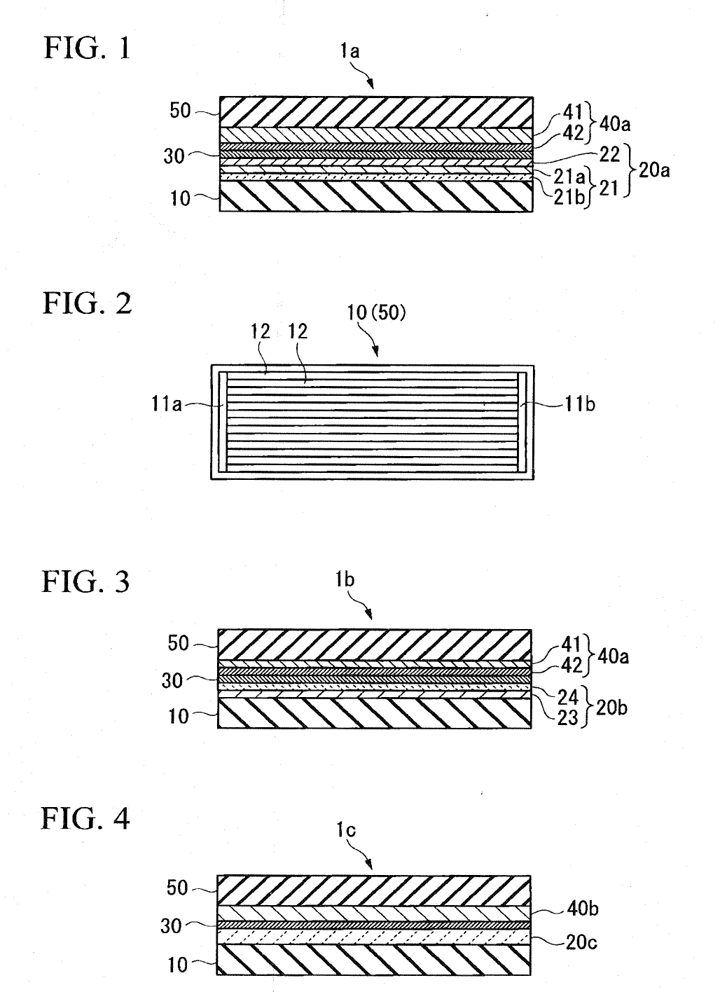

As shown in FIG. 2, the first separator 10 is in a rectangular sheet shape, and includes a supplying opening 11a for an oxidizing agent which is in a rectangular shape along the width direction at one side in a longitudinal direction of the separator 10 and a discharging opening 11b for an oxidizing agent which is in a rectangular shape along the width direction at the other side in a longitudinal direction of the separator 10. In addition, a plurality of linear grooves 12 are formed from the supplying opening 11a to the discharging opening 11b. That is, the plurality of linear grooves 12 are formed along the longitudinal direction of the first separator 10. In general, the separator, in which the plurality of linear grooves 12 are formed along the longitudinal direction, is called “a straight type separator”.

In the first separator 10, an oxidizing agent supplied from the supplying opening 11a flows in the grooves 12 and an oxidizing agent, which is not used in electric generation, is discharged from the discharging opening 11b. In the present invention, examples of the oxidizing agent include oxygen and air.

It is preferable that the first separator 10 have conductivity in order to function as an electrode. In addition, it is also preferable that the first separator 10 have corrosion resistance. Examples of the first separator 10 having conductivity and corrosion resistance include a separator made of graphite, a separator made of metal such as stainless steel.

### [First Conductive Porous Member]

The first conductive porous member 20a includes a first gas diffusion layer 21 positioned at the side of the first separator 10 and a first catalyst layer 22 positioned at the side of the electrolyte membrane 30.

First Gas Diffusion Layer

The first gas diffusion layer 21 in this embodiment includes an orientation layer 21a including a binder resin and conductive fibers which are orientated along the flow direction of the oxidizing agent in fluid conditions and a non-orientation layer 21b which is porous and does not contain conductive fibers. The first gas diffusion layer 21 diffuses the oxidizing agent which is supplied from the supplying opening 11a of the first separator 10.

In the present invention, “conductive fibers orientated along the flow direction of an oxidizing agent” means conductive fibers orientated in a range from 0° to 35° with respect to the flow direction of the oxidizing agent.

Since the orientation layer 21a contains conductive fibers in the binder resin, it is porous.

Examples of the binder resin contained in the orientation layer 21a include polytetrafluoroethylene (PTFE), polyvinylidene fluoride (polyfluoride vinylidene; PVDF), polyhexafluoropropylene (HFP), and ethylene•tetrafluoroethylene copolymer (ETFE).

Examples of the conductive fibers contained in the orientation layer 21a include carbon fibers, and metal fibers.

Specifically, examples of the carbon fibers include vapor grown carbon fibers, polyacrylonitrile (PAN) carbon fibers, phenol carbon fibers, and pitch carbon fibers.

Examples of the metal fibers include stainless steel fibers, gold fibers, and silver fibers. However, any metal fibers can be used as long as it is difficult for them to be oxidized in an oxidation atmosphere. Among these metal fibers, stainless steel fibers are preferable, because stainless steel fibers can endure an oxidation atmosphere in the cell 1a, in addition to having particularly high conductivity.

However, among the conductive fibers including carbon fibers and metal fibers, carbon fibers are preferable, because carbon fibers have low electrical resistance, and electrical charge is effectively collected, and have higher electric generating performance.

In addition, an aspect ratio of the conductive fibers is preferably in a range from 50 to 10,000, and more preferably in a range from 100 to 2,000. When the aspect ratio of the conductive fibers is 50 or more, electric generating performance of the fuel cell is higher. When it is 10,000 or less, they are easily orientated.

Since the orientation layer 21a contains the conductive fibers, the orientation layer 21a displays electrical conductivity. However, the electrical conductivity of the orientation layer 21a may be improved by adding a conductive material (denoted as “other conductive material” below) besides the conductive fibers. Examples of other conductive materials include carbon black, acetylene black, graphite, and fullerene.

The mass ratio (a/b) between an amount (a) of the conductive fibers and the other conductive material and an amount (b) of the binder resin in the orientation layer 21a is preferably in a range from 0.5 to 3.0. When the ratio (a/b) is 0.5 or more, the amount of orientated conductive fibers is large, and electric generating performance of the fuel cell including the cell 1a is improved. When it is 3.0 or less, the orientation layer 21a is easily formed.

Examples of the non-orientation layer 21b include a layer having the same components as the orientation layer 21a except that the conductive fibers orientated along the flow direction of the oxidizing agent are not contained, a layer including the binder resin and the other conductive material, carbon paper, and carbon cloth.

The thickness of the first gas diffusion layer 21 is preferably in a range from 100 to 400 μm. When the thickness is 100 μm or more, the first gas diffusion layer 21 is difficult to rupture. When it is 400 μm or less, electrical resistance in the thickness direction is small. Moreover, the thickness of the first gas diffusion layer 21 is measured using a micrometer (multipoint thickness meter) in the present invention.

First Catalyst Layer

The first catalyst layer 22 includes an ion catalyst, conductive material, and a binder resin, and generates oxygen ions from the oxidizing agent added. The first catalyst layer 22 is porous, because the ion catalyst and the conductive material are added to the binder resin.

A platinum catalyst is preferable as the ion catalyst, because it can generate oxygen ion (O²⁻) with high efficiency from the oxidizing agent.

In addition, it is preferable for the ion catalyst to be supported in a carbon material, because catalyst efficiency is improved. Examples of the carbon material for supporting the ion catalyst include carbon black such as furnace black and channel black.

Carbon black of any grade is used without depending on a specific surface area and particle diameter. However, when performance and productivity of the catalyst layer are concerned, high structure carbon black, which has a large specific surface area and provides large secondary coagulated particles, is preferable. Examples of the high structure carbon black include Ketjen EC marketed by Lion Akzo Co. Ltd., and Vulcan XC72R marketed by Cabot Co. Ltd. These high structure carbon blacks are preferably used, because they have high dispersibility in the slurry containing the ion catalyst, and low electrical resistance.

Examples of the carbon material other than carbon black include acetylene black, graphite, and fullerene.

Examples of the conductive include carbon black, acetylene black, graphite, and fullerene.

An ion conductive resin is preferably used as the binder resin contained in the first catalyst layer 22, because hydrogen ions from the electrolyte membrane 30 easily pass through. An ion conductive resin having a proton (hydrogen ion) exchange group is used. As the proton exchange group, a sulfonic acid group, carboxylic acid group, phosphoric acid group, etc. are preferably used. In particular, a resin having a proton exchange group including a fluoroalkyl main chain and fluoroalkyl ether side chains such as the commercial product of NAFION® marketed by DuPont, is more preferably used.

It is preferable that the first catalyst layer 22 includes conductive fibers orientated along the flow direction of the oxidizing agent, because electric generating performance is improved. As the conductive fibers preferably contained in the first catalyst layer 22, the same conductive fibers as those contained in the orientation layer 21a can be used.

The mass ratio (c/d) between a total amount (c) of the ion catalyst and the conductive material and an amount (d) of the binder resin in the first catalyst layer 22 is preferably in a range from 0.5 to 3.5. When the ratio (c/d) is 0.5 or more, electric generating performance of the fuel cell including the cell 1a is improved. When it is 3.5 or less, the first catalyst layer 22 is easily formed.

In addition, the amount of the catalyst added in the first catalyst layer 22 is preferably in a range from 15 to 40% by mass in the first catalyst layer 22. When the percentage is less than 15% by mass, the electric generating performance of the fuel cell including the cell 1a may be decreased. When it is more than 40% by mass, the electric generating performance of the fuel cell may also be sometimes decreased. The reasons for decreasing the electric generating performance are unexplained, but it is considered that when the amount of the catalyst added is increased, the relative amount of the ion conductive resin is decreased, and ion transport properties in the first catalyst layer 22 are decreased.

The thickness of the first catalyst layer 22 is preferably in a range from 10 to 50 μm. When the thickness is 10 μm or more, the first catalyst layer 22 is difficult to rupture. When it is 50 μm or less, the distance in which ions move in the thickness direction is small. Moreover, the thickness of the first catalyst layer 22 is also measured using a micrometer (multipoint thickness meter) in the present invention.

The void percentage of the first conductive porous member 20a is preferably in a range from 15 to 75%. When the void percentage is 15% or more, because the first conductive porous member 20a has sufficient voids, fluid easily flows. When it is 75% or less, the first conductive porous member 20a has sufficient strength. Moreover, the void percentage is obtained by measuring the volume of pores having a diameter in a range from 6 nm to 900 μm using PoreMaster 33P, which is a mercury intrusion porosimeter marketed by Yuasa Ionics Inc.

### [Electrolyte Membrane]

As the electrolyte membrane 30, a solid polymer electrolyte membrane having ion conductivity, for example, a commercial product NAFION® 117 marketed by DuPont, can be used.

### [Second Conductive Porous Member]

The second conductive porous member 40a includes a second gas diffusion layer 41 and a second catalyst layer 42.

Second Gas Diffusion Layer

As the second gas diffusion layer 42, the first gas diffusion layer 21 may be used, or only the non-orientation layer 21b of the first gas diffusion layer 21 may be used.

Second Catalyst Layer

As the second catalyst layer 42, the first catalyst layer 22 may be used. However, an alloy catalyst including platinum and ruthenium is preferably used, because the alloy catalyst generates hydrogen ions (H⁺) from the fuel with high efficiency.

### [Second Separator]

As the second separator 50, the first separator 10 may be used. In the second separator 50, fuel supplied from the supplying opening 11a flows in the grooves 12, and fuel which is not used to generate power is discharged from the discharging opening 11b. Examples of the fuel include hydrogen, and alcohols such as methanol and ethanol.

### [Production Method]

One embodiment of the production method for the cell 1a will be explained.

In order to produce the cell 1a, the first gas diffusion layer 21, the second gas diffusion layer 41, the first catalyst layer 22, and the second catalyst layer 42 are prepared in advance.

In order to produce the first gas diffusion layer 21, a conductive fiber-containing layer is produced. In order to produce the conductive fiber-containing layer, first, a slurry containing conductive fibers, a binder resin, and a dispersant is prepared.

Examples of the dispersant for the slurry include methanol, ethanol, dimethylformamide, acetone, methylethylketone, toluene, and N-methylpyrrolidone.

Then, the conductive fibers in the slurry are subjected to an orientation treatment to form a conductive fiber-containing layer which finally becomes the first orientation layer 21a. The orientation treatment means a treatment in which conductive fibers are orientated along one direction. As the orientation treatment, a treatment in which a shearing force is applied the conductive fiber-containing slurry along one direction, is used. Specifically, examples of the orientation treatment include a roll coating method and a doctor blade method, in which the conductive fiber-containing slurry is coated so as to extend in one direction, a rolling method in which the conductive fiber-containing slurry is coated on a sheet and then the sheet is rolled by applying pressure using a roller, and a screen printing method.

After that, the first gas diffusion layer 21 is prepared by laminating the non-orientation layer 21b on the conductive fiber-containing layer. As the laminating method, a pressure attachment method using a roller may be used.

In order to prepare the second gas diffusion layer 41, at first, a slurry for the second gas diffusion layer 41 including a conductive material, a binder resin, and a dispersant is prepared.

Examples of the dispersant used in the slurry for the second gas diffusion layer 41 include methanol, ethanol, dimethylformamide, acetone, methylethylketone, toluene, and N-methylpyrrolidone.

Then, the slurry for the second gas diffusion layer 41 is coated on a substrate, and dried to prepare the second gas diffusion layer 41. As the substrate, the substrate used for preparing the first and second catalyst layers 22 and 42 may be used. In addition, the same coating and drying method as that used for preparing the first and second catalyst layers 22 and 42 is also used.

In order to prepare the first catalyst layer 22 and the second catalyst layer 42, at first, a slurry for the catalyst layers containing an ion catalyst, conductive material, a binder resin, and a dispersant, and if necessary, conductive fibers is prepared. As the dispersant used for preparing the slurry, water is preferable, and ion-exchange water is more preferable. Besides water, for example, methanol, ethanol, propanol, or butanol may be also used.

When the ion catalyst, the conductive material, the binder resin, and the dispersant are mixed, in order to improve dispersibility of the ion catalyst, it is preferable to use an ultrasonic dispersing device.

After that, the obtained slurry for the catalyst layers is coated on a substrate, and dried to prepare the first and second catalyst layers 22 and 42 having a substrate.

Examples of the substrate include a film made of polyethylene terephthalate, polytetrafluoroethylene, polyimide, or polyethylene naphthalate (PEN). In addition, a resin film having surfaces subjected to a release treatment may also be used.

Examples of the coating method of the slurry for the catalyst layers include a dip coating method, spray coating method, roll coating method, doctor blade method, gravure coating method, and screen printing method. However, when the first catalyst layer 22 includes conductive fibers orientated in one direction, a coating method in which the slurry for the catalyst layer is extended in one direction such as a roll coating method and doctor blade method, or screen printing is preferably used. Drying may be natural drying or heating drying using a dryer.

Then, the first catalyst layer 22 having a substrate is laminated on one surface of the electrolyte membrane 30, the second catalyst layer 42 having a substrate is also laminated on the other surface of the electrolyte membrane 30, and the substrates are peeled off from the first and second catalyst layers 22 and 42.

Then, the first gas diffusion layer 21 is laminated on the first catalyst layer 22 such that the conductive fiber-containing layer 21a contacts the first catalyst layer 22 to produce the first conductive porous member 20a which is a conductive fiber-containing porous member. Then, the second gas diffusion layer 41 is laminated on the second catalyst layer 42 to produce the second porous member 40a.

Then, the first separator 10 is laminated on the first gas diffusion layer 21 such that the conductive fibers contained in the conductive fiber-containing layer are orientated along the flow direction of the oxidizing agent. The conductive fiber-containing layer becomes an orientation layer 21a by this laminating.

After that, the second separator 50 is laminated on the second gas diffusion layer 41 to produce the cell 1a.

In the cell 1a of this embodiment, since the conductive fibers contained in the orientation layer 21a are orientated along the flow direction of the oxidizing agent, water generated in the first catalyst layer 22 during electric generation easily moves along with the flow of the oxidizing agent to the discharging opening 11b formed in the first separator 10. Therefore, according to the cell 1a of this embodiment, since water generated during electric generation is easily discharged from the discharging opening 11b, it is possible to prevent water from disturbing the flow of the oxidizing agent. As a result, electric generating performance is improved.

### Second Embodiment

The second embodiment of the cell for a fuel cell of the present invention is explained below. In this embodiment, a conductive porous member includes a gas diffusion layer and an ion catalyst layer, and the catalyst layer is an orientation layer.

FIG. 3 shows the cell of this embodiment. A cell 1b shown in FIG. 3 includes a first separator 10, a first conductive porous member 20b, an electrolyte membrane 30, a second conductive porous member 40a, and a second separator 50, and these are laminated. Specifically, the cell 1b includes the electrolyte membrane 30, the first and second conductive porous members 20b and 40a which are laminated so as to sandwich the electrolyte membrane 30, and the first and second separators 10 and 50 which are laminated so as to sandwich the electrolyte membrane 30 and the first and second conductive porous members 20b and 40a.

Moreover, the same components of the cell 1b of this embodiment as those of the cell 1a of the first embodiment have the same reference numerals. Thereby, an explanation of those same components is omitted in this embodiment.

### [First Conductive Porous Member]

The first conductive porous member 20b of this embodiment includes a first gas diffusion layer 23 positioned at the side of the first separator 10 and a first catalyst layer 24 positioned at the side of the electrolyte membrane 30.

The void percentage of the first conductive porous member 20b equals the void percentage of the first conductive porous member 20a in the first embodiment.

First Gas Diffusion Layer

The first gas diffusion layer 23 in this embodiment includes a conductive material but does not include conductive fibers orientated along the flow direction of the oxidizing agent. As the first gas diffusion layer 23, the non-orientation layer 21b in the first embodiment may be used.

The thickness of the gas diffusion layer 23 equals the thickness of the first gas diffusion layer 21 in the first embodiment.

First Catalyst Layer

The first catalyst layer 24 is an orientation layer which essentially includes an ion catalyst, conductive fibers orientated along the flow direction of the oxidizing agent, and a binder resin, and optionally includes a conductive material. As the ion catalyst and the conductive fibers, the ion catalyst and conductive fibers used in the first embodiment may be used. In addition, as the binder resin, the binder resin used in the first catalyst layer 22 of the first embodiment may be used.

The mass ratio (e/f) between an total amount (e) of the ion catalyst and conductive fibers and an amount (f) of the binder resin in the first catalyst layer 24 is preferably in a range from 0.5 to 3.5. When the ratio (e/f) is 0.5 or more, electric generating performance of the fuel cell including the cell 1b is improved. When it is 3.5 or less, the first catalyst layer 24 is easily formed.

In addition, the amount of the catalyst added to the first catalyst layer 24 is preferably in a range from 15 to 40% by mass in the first catalyst layer 24. When the percentage is less than 15% by mass, the electric generating performance of the fuel cell including the cell 1b may be decreased. When it is more than 40% by mass, the electric generating performance of the fuel cell may also be sometimes decreased. The reasons for decreasing the electric generating performance are unexplained, but it is considered that when the amount of the catalyst added is increased, the relative amount of the ion conductive resin is decreased, and ion transport properties in the first catalyst layer 24 are decreased.

The thickness of the first catalyst layer 24 equals the thickness of the first catalyst layer 22 in the first embodiment.

### [Production Method]

One embodiment of the production method for the cell 1b will be explained.

In order to produce the cell 1b, the first gas diffusion layer 23, the second gas diffusion layer 41, the first catalyst layer 24, and the second catalyst layer 42 are prepared in advance.

In order to produce the first gas diffusion layer 24, a conductive fiber-containing slurry, which includes an ion catalyst, conductive fibers, a binder resin, and a dispersant, and optionally includes conductive material, is prepared. As the dispersant used for preparing the conductive fiber-containing slurry, water is preferable, and ion-exchange water is more preferable. Besides water, for example, methanol, ethanol, propanol, or butanol may be also used.

When the ion catalyst, the conductive fibers, the binder resin, and the dispersant are mixed, in order to improve dispersibility of the ion catalyst, it is preferable to use an ultrasonic dispersing device.

After that, the obtained conductive fiber-containing slurry is subjected to an orientation treatment to obtain a conductive fiber-containing layer in which conductive fibers are orientated along one direction. The obtained conductive fiber-containing layer is used as the first catalyst layer 24. The same orientation treatment as those in the first embodiment may be used.

Then, the first gas diffusion layer 23, which is the same layer as the non-orientation layer 21b in the first embodiment, is prepared. The second gas diffusion layer 41 and the second catalyst layer 42 are prepared in the same manner as in the first embodiment.

Then, the first catalyst layer 24, which is a conductive fiber-containing layer, is laminated on one surface of the electrolyte membrane 30, and the second catalyst layer 42 is also laminated on the other surface of the electrolyte membrane 30. The first gas diffusion layer 23 is laminated on the first catalyst layer 24 to form the first conductive porous member 20b which is a conductive fiber-containing porous member. The second gas diffusion layer 41 is also laminated on the second catalyst layer 42 to form the second conductive porous member 40a.

Then, the first separator 10 is laminated on the first gas diffusion layer 23 such that the conductive fibers contained in the first catalyst layer 24 are orientated along the flow direction of the oxidizing agent. The first catalyst layer 24 becomes an orientation layer by this laminating.

After that, the second separator 50 is laminated on the second gas diffusion layer 41 to produce the cell 1b.

In the cell 1b of this embodiment, since the conductive fibers contained in the first catalyst layer 24 are orientated along the flow direction of the oxidizing agent, water generated in the first catalyst layer 24 during electric generation easily moves along with the flow of the oxidizing agent to the discharging opening 11b formed in the first separator 10. Therefore, according to the cell 1b of this embodiment, since water generated during electric generation is easily discharged from the discharging opening 11b, it is possible to prevent water from disturbing the flow of the oxidizing agent. As a result, electric generating performance is improved.

### Third Embodiment

The third embodiment of the cell for a fuel cell of the present invention is explained below. In this embodiment, a conductive porous member is an orientation layer.

FIG. 4 shows the cell of this embodiment. A cell 1c shown in FIG. 4 includes a first separator 10, a first conductive porous member 20c, an electrolyte membrane 30, a second conductive porous member 40c, and a second separator 50, and these are laminated. Specifically, the cell 1c includes the electrolyte membrane 30, the first and second conductive porous members 20c and 40b which are laminated so as to sandwich the electrolyte membrane 30, and the first and second separators 10 and 50 which are laminated so as to sandwich the electrolyte membrane 30 and the first and second conductive porous members 20c and 40b.

Moreover, the components of the cell IC of this embodiment which are the same as the components of the cell 1a of the first embodiment have the same reference numerals. Thereby, an explanation for those same components is omitted in this embodiment.

### [First Conductive Porous Member]

The first conductive porous member 20c of this embodiment is an orientation layer which includes an ion catalyst, conductive fibers orientated along the flow direction of the oxidizing agent, and a binder resin, and is a conductive fiber-containing porous member. As the ion catalyst and the conductive fibers, the ion catalyst and conductive fibers used in the first embodiment may be used. In addition, as the binder resin, the binder resin used in the first catalyst layer 22 in the first embodiment may be used.

### [Second Conductive Porous Member]

The second conductive porous member 40b includes an ion catalyst, a binder resin, and conductive material. As the ion catalyst and the conductive fibers, the ion catalyst and conductive fibers used in the first embodiment may be used. In addition, as the binder resin, the binder resin used in the first catalyst layer 22 in the first embodiment may be used.

The thickness of the first and second conductive porous members 20c and 40b is preferably in a range from 50 to 300 μm. When the thickness is 50 μm or more, the first and second conductive porous members 20c and 40b are difficult to rupture. When it is 300 μm or less, electrical resistance in the thickness direction is small.

The first and second conductive porous members 20c and 40b in this embodiment have both functions of the gas diffusion layer and the catalyst layer in the first and second embodiments.

### [Production Method]

One embodiment of the production method for the cell 1c will be explained.

In order to produce the cell 1c, the first conductive porous member 20c, and the second porous member 40b are prepared in advance.

In order to produce the first conductive porous member 20c, at first, a conductive fiber-containing slurry, which includes an ion catalyst, conductive fibers, a binder resin, and a dispersant, is prepared.

Then, the obtained conductive fiber-containing slurry is subjected to an orientation treatment to obtain a conductive fiber-containing layer in which conductive fibers are orientated along one direction. Only the obtained conductive fiber-containing layer is used as the first conductive porous member 20c. The same orientation treatment as those in the first embodiment may be used.

In order to produce the second conductive porous member 40b, at first, a slurry for the second conductive porous member, which includes an ion catalyst, conductive material, a binder resin, and a dispersant, is prepared. Then, the slurry is coated on a substrate and dried to obtain a second conductive porous member 40b having the substrate.

Then, the first conductive porous member 20c having the substrate, which is a conductive fiber-containing porous member, is laminated on one surface of the electrolyte membrane 30, the second conductive porous member 40b having the substrate is also laminated on the other surface of the electrolyte membrane 30. After that, the substrates are peeled off from the first and second conductive porous members 20c and 40b.

Then, the first separator 10 is laminated on the first conductive porous member 20c such that the conductive fibers contained in the first conductive porous member 20c are orientated along the flow direction of the oxidizing agent.

After that, the second separator 50 is laminated on the second conductive porous member 40b to produce the cell 1c.

In the cell 1c of this embodiment, since the conductive fibers contained in the first conductive porous member 20c are orientated along the flow direction of the oxidizing agent, water generated in the first conductive porous member 20c during electric generation easily moves along with the flow of the oxidizing agent to the discharging opening 11b formed in the first separator 10. Therefore, according to the cell 1c of this embodiment, since water generated during electric generation is easily discharged from the discharging opening 11b, it is possible to prevent water from disturbing the flow of the oxidizing agent. As a result, electric generating performance is improved.

Moreover, the present invention is not limited to the first to third embodiments. For example, the first gas diffusion layer includes one orientation layer in the first embodiment. However, the first gas diffusion layer may include two or more orientation layers. In addition, the first gas diffusion layer may not include the non-orientation layer and the first gas diffusion layer may be the orientation layer.

Furthermore, the catalyst layer is the orientation layer in the second embodiment. However, the catalyst layer may include the non-orientation layer containing an ion catalyst.

Moreover, the straight type separator (ref. FIG. 2) is used as the separator in the first to third embodiments. However, a serpentine type separator, and a grid type separator may also be used besides the straight type separator.

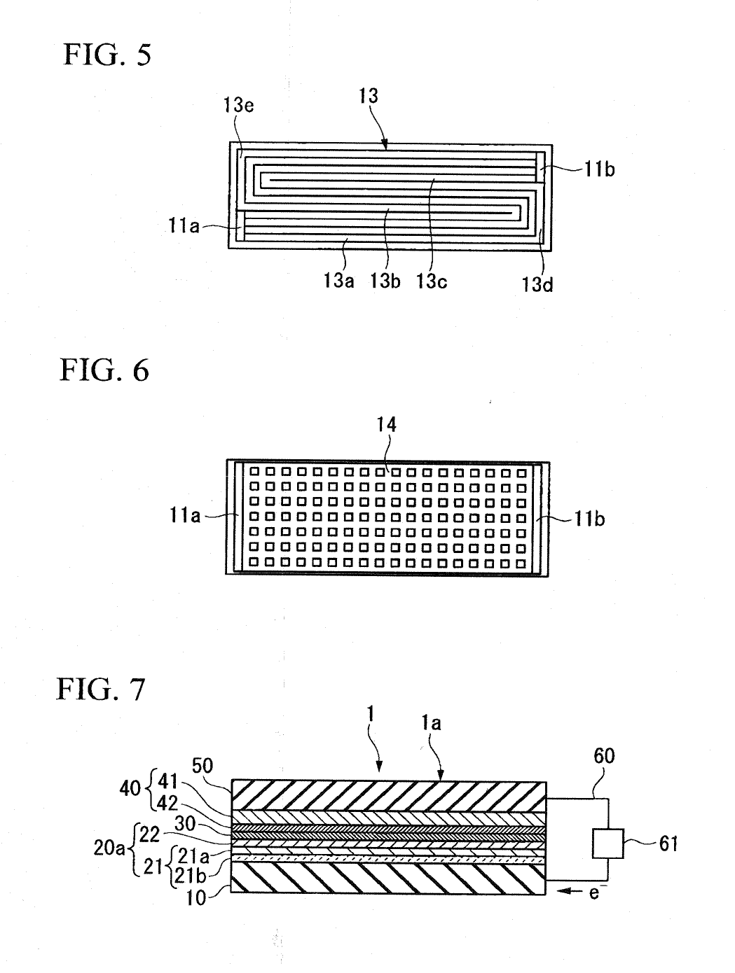

Examples of the serpentine type separator include, as shown in FIG. 5, a separator which is a rectangular shaped sheet. The separator includes a supplying opening 11a which is formed at about one corner (first corner) and is substantially rectangular having a long side along the width direction of the separator, a discharge opening 11b which is formed at about a second corner positioned diagonally to the first corner and is substantially rectangular having a long side along the width direction of the separator, and grooves 13 having straight parts and turned around parts, in which fluid changes its flow direction, from the supplying opening 11a to the discharging opening 11b.

Specifically, the grooves 13 include first to third main parts 13a, 13b, and 13c formed along the longitudinal direction of the separator; a first turned around part 13d which is formed along the width direction of the separator, connects the first main part 13a and the second main part 13b, and reverses the flow direction of fluid; and a second turned around part 13e which is formed along the width direction of the separator, connects the second main part 13b and the third main part 13c, and reverses the flow direction of fluid.

In the serpentine type separator, fluid supplied from the supplying opening 11a flows in the first main part 13a and reaches the first turned around part 13d. The flow direction of the fluid is reversed at the first turned around part 13d. After that, the fluid flows in the second main part 13b and reaches the second turned around part 13e. The flow direction of the fluid is also reversed at the second turned around part 13e. Then, the fluid flows in the third main part 13c, and reaches the discharging opening 11b.

The first and second turned around parts 13d and 13e are formed along the width direction of the separator. However, the area of the first and second turned around parts 13d and 13e is small relative to the entire area of the groove 13 from the supplying opening 11a to the discharging opening 11b. Therefore, when the serpentine type separator is used, it is sufficient that the conductive fibers in the orientation layer be orientated along the first to third main parts 13a to 13c, and it is not necessary that the conductive fibers in the orientation layer which correspond to the first and second turned around parts 13d and 13e be orientated.

The grid type separator is tetragonal and includes the supplying opening 11a in a rectangular shape having a long side along the short side of the separator, the discharging opening 11b in a rectangular shape having a long side along the other short side of the separator, and grooves 14 in a grid shape formed between the supplying opening 11a and the discharging opening 11b, as shown in FIG. 6.

In the grid type separator, almost all of the fluid supplied from the supplying opening 11a flows linearly toward the discharging opening 11b.

In addition, in the first to third embodiments, the second conductive porous member is different from the first conductive porous member. However, the second conductive porous member may be the same as the first conductive porous member.

In particular, when fuel is liquid such as methanol, since the fuel easily contacts the ion catalyst in the second conductive porous member, it is preferable that the second conductive porous member, which is the same as the first conductive porous member, be used, and that the conductive fibers contained in the second conductive porous member be orientated along the flow direction of the fuel.

### [Fuel Cell]

The polymer electrolyte fuel cell (abbreviated as “fuel cell” below) of the present invention will be explained using the cell 1a obtained in the first embodiment.

FIG. 7 shows one of the fuel cell according to the present invention. The fuel cell 1 includes the cell 1a, and the first separator 10 and the second separator 50 are connected via an outer circuit 60 including a resister 61.

The method for electric generation using the fuel cell 1, hydrogen as fuel, and oxygen as an oxidizing agent will be explained.

At first, hydrogen is supplied from the supplying opening 11a of the second separator 50 and is introduced to the second gas diffusion layer 41, and diffused to spread to the entire of the second gas diffusion layer 41. Then, the hydrogen is introduced to the second catalyst layer 42, and dissociated by the ion catalyst into hydrogen ions and electrons there. Moreover, hydrogen, which does not reach the second catalyst layer 42 and is not used, is discharged from the discharging opening 11b of the second separator 50.

Oxygen is supplied from the supplying opening of the first separator 10 and is introduced to the first gas diffusion layer 21, and diffused to spread to the entire of the first gas diffusion layer 41. Then, the oxygen is introduced to the first catalyst layer 22. Moreover, oxygen, which does not reach the first catalyst layer 22 and is not used, is discharged from the discharging opening 11b of the first separator 11.

The hydrogen ions generated in the second catalyst layer 42 pass through the electrolyte membrane 30 and reach the first catalyst layer 22. In contrast, electrons (e) pass through the second gas diffusion layer 41 and the second separator 50, and flow in the outer circuit 60. The flow of electrons, that is, electric current, in the outer circuit 60 generates electricity.

After that, the electrons flowing in the outer circuit 60 pass through the first separator 10 and the first gas diffusion layer 21, and reach the first catalyst layer 22. The electrons that have reached the first catalyst layer 22 are combined with oxygen to produce oxygen ions by the ion catalyst. Then, the produced oxygen ions react with hydrogen ions passed through the electrolyte membrane 30 to produce water.

These processes are continuously repeated to generate electric power.

Since the fuel cell of the present invention includes the cell 1a, 1b, or 1c, the water generated during electric generation is easily discharged from the discharging opening 11b of the first separator 10. Therefore, it is possible to prevent water from disturbing the flow of the oxidizing agent. As a result, electric generating performance is improved.

### EXAMPLES

The cell for a fuel cell, the production method for the cell, and the polymer electrolyte fuel cell including the cell for a fuel cell according to the present invention will be explained in more detailed referring to the following Examples and Comparative Examples.

### Example 1

### [First Conductive Porous Member (Conductive Porous Member at a Cathode Side)]

First Gas Diffusion Layer A (Gas Diffusion Layer at a Cathode Side)

10 g of acetylene black (conductive material), 10 g of vapor grown carbon fibers (aspect ratio: 200), 15 g of polytetrafluoroethylene (PTFE) (binder resin) were mixed, methanol was delivered by dropping in the mixture, and they were mixed to produce a conductive fiber-containing slurry.

The obtained conductive fiber-containing slurry was coated on the surface of a PTFE sheet, and dried. After drying, the coated slurry was peeled from the PTFE sheet, and extended by applying pressure using a roll press such that the thickness was 50 μm. Then, the vapor grown carbon fibers were orientated in one direction to produce the conductive fiber-containing layer.

After that, the conductive fiber-containing layer was pressed and attached to a carbon paper (non-orientation layer) having the thickness of 200 μm using a roll press, and they were heated at 370° C. in the atmosphere to produce the first gas diffusion layer A.

First Catalyst Layer A (Catalyst Layer at a Cathode Side)

1 g of platinum-supported carbon black (ion catalyst), 2.5 g of NAFION® solution DE2020 (ion conductive resin) marketed by DuPont, 0.3 g of vapor grown carbon fibers, and 0.2 g of acetylene black were added to 8 g of water, they were mixed in a mortar, and they were mixed additionally using an ultrasonic dispersing device to produce a conductive fiber-containing slurry. The conductive fiber-containing slurry was coated on the surface of PTFE sheet such that the amount of the platinum catalyst supported was 1 mg/cm² by a doctor blade method. Then, the slurry was dried at 50° C., and the vapor grown carbon fibers were orientated along one direction to produce the first catalyst layer A (conductive fiber-containing layer) having a substrate.

### [Second Conductive Porous Member (Conductive Porous Member at an Anode Side)]

Second Gas Diffusion Layer (Gas Diffusion Layer at an Anode Side)

Acetylene black was dispersed in N-methylpyrrolidone solution of vinylidene polyfluoride (PVDF) such that the mass ratio (acetylene black:PVDF) between acetylene black and PVDF was 2:1 to produce a slurry for a conductive porous sheet. Then, the slurry was coated on the surface of a polyethylene naphthalene (PEN) sheet by a doctor blade method, and they were dried at 150° C. for 1 hour. After that, the PEN sheet was peeled off to produce a conductive porous sheet having the thickness of 50 μm.

After that, the conductive porous sheet was pressed and attached with heat to carbon paper having the thickness of 200 μm using a roll press at 200° C. to produce the second gas diffusion layer.

Second Catalyst Layer (Catalyst Layer at an Anode Side)

1 g of platinum-supported carbon black, 2.5 g of NAFION® solution DE2020 marketed by DuPont, and 0.5 g of acetylene black were added to 8 g of water, and they were mixed in a mortar, and were mixed additionally using an ultrasonic dispersing device to produce a slurry for a catalyst layer. The slurry for a catalyst layer was coated on the surface of a PTFE sheet such that the amount of the platinum catalyst supported was 1 mg/cm² by a doctor blade method. Then, the slurry was dried at 50° C. to produce the second catalyst layer having a substrate.

### [First and Second Separators]

As the first and second separators, a straight type separator was used, which was made of graphite and were plates in a rectangular shape including the supplying opening 11a in a rectangular shape having a long side at the edge of the short side of the plate, the discharging opening 11b in a rectangular shape having a long side at the edge of the other short side of the plate, and linear grooves 12 from the supplying opening 11a to the discharging opening 11b, that is, linear grooves 12 are formed along the longitudinal direction of the separator.

The produced first gas diffusion layer A, the first catalyst layer A, the second gas diffusion layer, and the second catalyst layer were cut into pieces of 2.3 cm×2.3 cm.

Then, the first catalyst layer A having a substrate was laminated on the surface of the electrolyte membrane (NAFION® 117 marketed by DuPont), and the second catalyst layer having a substrate was laminated on the other surface thereof, and then the substrates were peeled off. After peeling off the substrates, they were pressed and attached by a hot press at 120° C. to produce a membrane electrode assembly.

Then, the first gas diffusion layer A was laminated on the first catalyst layer A of the membrane electrode assembly such that the angle of the orientation direction of the vapor grown carbon fibers contained in the first catalyst layer A relative to the orientation direction of the vapor grown carbon fibers contained in the first gas diffusion layer A was 0°, that is, they were parallel, and that the conductive fiber-containing layer contacted the first catalyst layer A, and thereby the first conductive porous member was produced.

After that, the first separator was laminated on the first gas diffusion layer A of the first conductive porous member such that the angle of the orientation direction of the vapor grown carbon fibers contained in the conductive fiber-containing layer relative to the flow direction of the oxidizing agent was 0°, that is, they were parallel.

Furthermore, the second gas diffusion layer was laminated on the second catalyst layer such that the second catalyst layer contacted the conductive porous sheet, and thereby the second conductive porous member was produced. Then, the second separator was laminated on the second gas diffusion layer of the second conductive porous member to produce the cell.

### Example 2

The cell was prepared in a manner identical to that of Example 1, except that when the first separator was laminated on the first gas diffusion layer A, the angle of the orientation direction of the vapor grown carbon fibers contained in the conductive fiber-containing layer relative to the flow direction of the oxidizing agent was 30°. In other words, the angle of the orientation direction of the vapor grown carbon fibers contained in the first catalyst layer A relative to the flow direction of the oxidizing agent was 30° in Example 2.

### Example 3

The cell was prepared in a manner identical to that of Example 1, except that a first catalyst layer B was produced in the same manner as in the first catalyst layer A without adding the vapor grown carbon fibers, and the first catalyst layer B was used instead of the first catalyst layer A.

### Example 4

The cell was prepared in a manner identical to that of Example 3, except that when the first separator was laminated on the first gas diffusion layer A, the angle of the orientation direction of the vapor grown carbon fibers contained in the conductive fiber-containing layer of the first gas diffusion layer A relative to the flow direction of the oxidizing agent was 30°.

### Example 5

15 g of acetylene black and 15 g of PTFE were mixed, methanol was delivered by dropping in the mixture, and they were mixed to produce a slurry for a conductive porous sheet.

The obtained slurry for a conductive porous sheet was coated and dried on the surface of a PTFE sheet, and then the PTFE sheet was peeled off to produce a film including the slurry, and the film was extended by applying pressure using a roll press such that the thickness was 50 μm to produce a conductive porous sheet. Then, the conductive porous sheet was pressed and attached to carbon paper having the thickness of 200 μm using a roll press, and they were heated at 370° C. in the atmosphere to produce the first gas diffusion layer B.

After that, the cell was prepared in a manner identical to that of Example 1, except that the produced first gas diffusion layer B was used instead of the first gas diffusion layer A.

### Example 6

The cell was prepared in a manner identical to that of Example 1, except that the first gas diffusion layer B prepared in Example 5 was used instead of the first gas diffusion layer A, and that the angle of the orientation direction of the vapor grown carbon fibers contained in the first catalyst layer A relative to the flow direction of the oxidizing agent was 30°.

### Example 7

10 g of acetylene black and 10 g of vapor grown carbon fibers were added in 150 g of 10%-N-methylpyrrolidone solution of vinylidene polyfluoride to produce a conductive fiber-containing slurry. Then, the conductive fiber-containing slurry was coated on a PEN film by a doctor blade method, and the coating was dried at 150° C. for 1 hour. After that, the PEN film was peeled off to produce a conductive fiber-containing layer which contains vapor grown carbon fibers orientated along one direction and has the thickness of 50 μm.

After that, the conductive fiber-containing layer was pressed and attached to carbon paper having the thickness of 200 μm using a roll press at 200° C. to produce the first gas diffusion layer C.

The cell was prepared in a manner identical to that of Example 1, except that the first gas diffusion layer C was used instead of the first gas diffusion layer A.

### Example 8

The cell was prepared in a manner identical to that of Example 7, except that the first catalyst layer B was used instead of the first catalyst layer A and that when the first separator was laminated on the first gas diffusion layer C, the angle of the orientation direction of the vapor grown carbon fibers contained in the conductive fiber-containing layer relative to the flow direction of the oxidizing agent was 30°.

### Example 9

15 g of acetylene black was added in 150 g of 10%-N-methylpyrrolidone solution of vinylidene polyfluoride to produce a slurry for a conductive porous sheet. Then, the slurry for a conductive porous sheet was coated on a PEN film by a doctor blade method, and the coating was dried at 150° C. for 1 hour, and the PEN film was peeled off to produce a conductive porous sheet.

After that, the conductive porous sheet was pressed and attached to carbon paper having the thickness of 200 μm using a roll press to produce the first gas diffusion layer D.

The cell was prepared in a manner identical to that of Example 1, except that the first gas diffusion layer D was used instead of the first gas diffusion layer A.

### Example 10

10 g of acetylene black and 12 g of PAN type carbon fiber (aspect ratio: 900) were added in 200 g of 10%-N-methylpyrrolidone solution of vinylidene polyfluoride to produce a conductive fiber-containing slurry. Then, the conductive fiber-containing slurry was coated on a PEN film by a doctor blade method, and the coating was dried at 150° C. for 1 hour, and the PEN film was peeled off to produce a conductive fiber-containing layer which contains PAN type carbon fibers orientated along one direction and has the thickness of 100 μm. The conductive fiber-containing layer was used as the first gas diffusion layer E.

Then, the first catalyst layer A having a substrate was laminated on the surface of electrolyte membrane (NAFION® 117, marketed by DuPont), and the second catalyst layer having a substrate was laminated on the other surface of the electrolyte membrane. After peeling off the substrates, they were pressed and attached by a hot press at 120° C. to produce a membrane electrode assembly.

Then, the first gas diffusion layer E was laminated on the first catalyst layer A of the membrane electrode assembly such that the angle of the orientation direction of the vapor grown carbon fibers contained in the first catalyst layer A relative to the orientation direction of the PAN type carbon fibers contained in the first gas diffusion layer E was 30°.

After that, the first separator was laminated on the first gas diffusion layer E such that the angle of the orientation direction of the PAN type carbon fibers contained in the gas diffusion layer E relative to the flow direction of the oxidizing agent was 0°.

Furthermore, the second gas diffusion layer was laminated on the second catalyst layer such that the second catalyst layer contacted to the carbon paper. Then, the second separator was laminated on the second gas diffusion layer to produce the cell.

### Example 11

The cell was prepared in a manner identical to that of Example 10, except that the first catalyst layer B was used instead of the first catalyst layer A.

### Example 12

A first gas diffusion layer F was produced in a manner identical to that of the first gas diffusion layer E, except that the PAN type carbon fibers were not added. In addition, the first catalyst C, which was a conductive fiber-containing layer, was prepared in a manner identical to that of the first catalyst layer A, except that the PAN type carbon fibers were used instead of the vapor grown carbon fibers.

The cell was prepared in a manner identical to that of Example 10, except that the first catalyst layer C was laminated on the surface of the electrolyte membrane, and that the first gas diffusion layer F was laminated on the first catalyst layer C, and that the first separator was laminated on the first gas diffusion layer F such that the angle of the orientation direction of the PAN type carbon fibers contained in the first catalyst layer C relative to the flow direction of the oxidizing agent was 0°.

### Example 13

The first catalyst layer A having a substrate was laminated on the surface of an electrolyte membrane (NAFION® 117; marketed by DuPont), and the second catalyst layer having a substrate was laminated on the other surface of the electrolyte membrane, and they were pressed and attached by a hot press at 120° C., and the substrates were peeled off to produce a membrane electrode assembly. In this Example, only the first catalyst layer A was used as the first conductive porous member, and only the second catalyst layer was used as the second conductive porous member.

Then, the first separator was laminated on the first catalyst layer A of the membrane electrode assembly such that the angle of the orientation direction of the vapor grown carbon fibers contained in the first catalyst layer A relative to the flow direction of the oxidizing agent was 0°, that is, they were parallel. After that, the second separator was laminated on the second catalyst layer to produce the cell.

### Example 14

The cell was prepared in a manner identical to that of Example 13, except that the first catalyst layer C was used instead of the first catalyst layer A, and that the first separator was laminated on the first catalyst layer C such that the angle of the orientation direction of the PAN type carbon fibers contained in the first catalyst layer C relative to the flow direction of the oxidizing agent was 30°.

### Comparative Example 1

The comparative cell was prepared in a manner identical to that of Example 1, except that the first catalyst layer A, the first gas diffusion layer A, and the first separator were laminated such that the angle of the orientation direction of the vapor grown carbon fibers contained in the first catalyst layer A relative to the flow direction of the oxidizing agent was 60°, and that the angle of the orientation direction of the vapor grown carbon fibers contained in the conductive fiber-containing layer in the first gas diffusion layer A relative to the flow direction of the oxidizing agent was 60°.

### Comparative Example 2

The comparative cell was prepared in a manner identical to that of Example 7, except that the first catalyst layer A, the first gas diffusion layer C, and the first separator were laminated such that the angle of the orientation direction of the vapor grown carbon fibers contained in the first catalyst layer A relative to the flow direction of the oxidizing agent was 30°, and that the angle of the orientation direction of the vapor grown carbon fibers contained in the first gas diffusion layer C relative to the flow direction of the oxidizing agent was 90°.

### Comparative Example 3

10 g of acetylene black and 12 g of PAN type carbon fibers were added in 200 g of 10% N-methylpyrrolidone solution of vinylidene polyfluoride to produce a conductive fiber-containing slurry. Then, the conductive fiber-containing slurry was sprayed to a PEN film, and the coating was dried at 150° C. for 1 hour, and the PEN film was peeled off to produce a first gas diffusion layer G.

Then, 1 g of platinum-supported carbon black, 2.5 g of NAFION® solution DE2020 marketed by DuPont, 0.3 g of vapor grown carbon fibers, and 0.2 g of acetylene black were added to 8 g of water to prepare a conductive fibers-containing slurry for a catalyst layer. The prepared slurry was sprayed to a PTFE sheet to produce the first catalyst layer D.

Moreover, vapor grown carbon fibers were not orientated by spray coating.

After that, the comparative cell was prepared in a manner identical to that of Example 10, except that the first gas diffusion layer G was used instead of the first gas diffusion layer E, and that the first catalyst layer D was used instead of the first catalyst layer A.

### Comparative Example 4

The comparative cell was prepared in a manner identical to that of Example 13, except that only the first catalyst layer D prepared in Comparative Example 3 was used as the first conductive porous member instead of the first catalyst layer A.

### Comparative Example 5

The comparative cell was prepared in a manner identical to that of Example 1, except that the vapor grown carbon fibers were not contained in the first gas diffusion layer A and the first catalyst layer A.

The cell type, and the kinds, the orientation directions, and the angles (orientation angle in Tables) of the orientation direction relative to the flow direction of the oxidizing agent of carbon fibers contained in the first gas diffusion layer; and the kinds, the orientation directions, and the angles (orientation angle in Tables) of the orientation direction relative to the flow direction of the oxidizing agent of carbon fibers contained in the first catalyst layer are shown in Tables 1 and 2.

In Tables 1 and 2, the first conductive porous member of the cell in type A includes the first and second gas diffusion layers and the first catalyst layer, the first conductive porous member of the cell in type B includes the first gas diffusion layer and the first catalyst layer, and the first conductive porous member of the cell in type C includes one layer, that is, the first catalyst layer. In Tables 1 and 2, vapor grown carbon fibers are denoted by VGCF, and PAN type carbon fibers are denoted by PANCF.

TABLE 1

| | | Examples | | | | | | | | |
|---|---|---|---|---|---|---|---|---|---|---|
| | | 1 | 2 | 3 | 4 | 5 | 6 | 7 | 8 | 9 |
| Cell type | | A | | | | | | | | |
| First gas | Kinds of carbon fibers | VGCF | | | | None | | VGCF | | None |
| diffusion layer | Orientation angle (°) | 0 | 30 | 0 | 30 | — | — | 0 | 30 | — |
| First catalyst | Kinds of carbon fibers | VGCF | | None | | VGCF | | | | |
| layer | Orientation angle (°) | 0 | 30 | — | — | 0 | 30 | 0 | 0 | 0 |
| Cell voltage | at 100 mA/cm² (V) | 0.36 | 0.36 | 0.35 | 0.33 | 0.34 | 0.33 | 0.37 | 0.35 | 0.35 |
| | at 150 mA/cm² (V) | 0.30 | 0.28 | 0.25 | 0.23 | 0.24 | 0.22 | 0.29 | 0.25 | 0.22 |
| | Decrease ratio | 83 | 78 | 71 | 70 | 71 | 67 | 78 | 71 | 63 |

TABLE 2

| | | Example | | | | | Comparative Example | | | | |
|---|---|---|---|---|---|---|---|---|---|---|---|
| | | 10 | 11 | 12 | 13 | 14 | 1 | 2 | 3 | 4 | 5 |
| Cell type | | B | | | C | | A | | B | C | A |
| First gas | Kinds of carbon fibers | PANCF | | None | *1 | *1 | VGCF | | PANCF | *1 | None |
| diffusion | Orientation angle (°) | 0 | 0 | — | — | — | 60 | 90 | non- | — | — |
| layer | | | | | | | | | oriented | | |
| First | Kinds of carbon fibers | VGCF | None | PANCF | VGCF | PANCF | VGCF | | | | None |
| catalyst | Orientation angle (°) | 30 | — | 0 | 0 | 30 | 60 | 30 | non- | non- | — |
| layer | | | | | | | | | oriented | oriented | |
| Cell voltage | at 100 mA/cm² (V) | 0.32 | 0.31 | 0.33 | 0.33 | 0.31 | 0.34 | 0.31 | 0.25 | 0.27 | 0.27 |
| | at 150 mA/cm² (V) | 0.26 | 0.21 | 0.20 | 0.23 | 0.20 | 0.12 | 0.11 | 0.05 | 0.02 | 0.13 |
| | Decrease ratio | 81 | 68 | 61 | 70 | 65 | 35 | 35 | 20 | 7 | 48 |

In Table 2, *1 means the fuel cell does not include a first gas diffusion layer.

### [Electric Generating Performance Evaluation]

The first and second separators of the cell prepared in Examples 1 to 14 and Comparative Examples 1 to 5 were connected by an outer circuit to produce the fuel cell. Then the produced fuel cell was evaluated by the following methods. The evaluation results are shown in Tables 1 and 2.

### [Electric Generating Performance Evaluation Method]

Oxygen as the oxidizing agent was supplied from the supplying opening of the first separator of the cell at 200 ml/min. at 80° C. while hydrogen as the fuel was supplied from the supplying opening of the second separator at 100 ml/min., and thereby electric power was generated. After electric power generation for 2 hours, the conditions of the cell were stable. The current-voltage characteristics at 0.2 mA/(cm²·sec.) of the electrical current scanning rate were evaluated, that is, the voltage when the electric current density was 100 mA/cm² and 150 mA/cm² was measured. The voltage (cell voltage) was shown in Table 1. In addition, the decrease ratio is calculated by the following formula:

Decrease ratio: voltage at 150 mA/cm²/voltage at 100 mA/cm²×100 (%)

The decrease ratio is also shown in Table 1. Moreover, a higher decrease ratio means that when the electric current density is high, it is more difficult for the voltage to fall. The voltage was measured by connecting the potentiostat/galvanostat (trade name: Solartron 1287, marketed by Solartron Co. Ltd.) with the outer circuit.

According to the fuel cell in Examples 1 to 14 including the cell including the orientation layer in which carbon fibers were orientated along the flow direction of the oxygen, when the electric current density was increased, it was difficult for the voltage to fall. That is, it was confirmed that the cell of Examples 1 to 14 had excellent electric generating performance.

In contrast, according to the comparative fuel cell including the cell in Comparative Examples 1 to 5 which did not include the orientation layer, when the electric current density increased, the voltage fell. That is, it was confirmed that the comparative cell of Comparative Examples 1 to 5 had poor electric generating performance.

### Example 15

The cell was prepared in a manner identical to that of Example 1, except that the first conductive porous member of Example 1 was also used as the second conductive porous member. Moreover, the second conductive porous member was laminated on the electrolyte membrane such that the angle of the orientation direction of the vapor grown carbon fibers contained in the conductive fiber-containing layer in the second conductive porous member relative to the flow direction of the oxidizing agent was 0°.

### Example 16

The cell was prepared in a manner identical to that of Example 13, except that the first conductive porous member of Example 13 was also used as the second conductive porous member. Moreover, the second conductive porous member was laminated on the electrolyte membrane such that the angle of the orientation direction of the vapor grown carbon fibers contained in the conductive porous fiber-containing layer in the second conductive porous member relative to the flow direction of the fuel was 0°.

### [Electric Generating Performance Evaluation]

The first and second separators of the cell prepared in Examples 15 and 16 were connected by an outer circuit to produce the fuel cell. Then the produced fuel cell was evaluated by the following method. The evaluation results are shown in Table 3.

### [Electric Generating Performance Evaluation Method]

Oxygen as the oxidizing agent was supplied from the supplying opening of the first separator of the cell at 200 ml/min. at 80° C. while hydrogen as the fuel was supplied from the supplying opening of the second separator at 100 ml/min. in the cell of Example 15, and 5% by mass of methanol aqueous solution as the fuel was supplied from the supplying opening of the second separator at 1 ml/min. in the cell of Example 16, and thereby electric power was generated. Then, similar to the evaluation of the cell in Examples 1 to 14 and Comparative Examples 1 to 5, when the electric current density was 100 mA/cm² and 150 mA/cm², the voltage was measured, and the decrease ratio was calculated. These results are shown in Table 3.

TABLE 3

| | | Example | |
|---|---|---|---|
| | | 15 | 16 |
| Cell type | | A | C |
| First gas diffusion layer | Kinds of carbon fibers | VGCD | *1 |
| | Orientation angle (°) | 0 | — |
| First catalyst layer | Kinds of carbon fibers | VGCF | |
| | Orientation angle (°) | 0 | |
| Second gas diffusion | Kinds of carbon fibers | VGCF | *1 |
| layer | Orientation angle (°) | 0 | — |
| Second catalyst layer | Kinds of carbon fibers | VGCF | |
| | Orientation angle (°) | 0 | |
| Fuel | | hydrogen | methanol |
| Cell voltage | at 100 mA/cm² (V) | 0.38 | 0.39 |
| | at 150 mA/cm² (V) | 0.30 | 0.29 |
| | Decrease ratio | 79 | 74 |

In Table 3, *1 means the fuel cell does not include a first gas diffusion layer.

According to the fuel cell including the cell in Examples 15 and 16 including the first conductive porous member and the second conductive porous member which respectively have the orientation layer in which carbon fibers contained were orientated along the flow direction of the fluid, when the electric current density was increased, it is difficult for the voltage to fall. That is, it was confirmed that the cell of Examples 1 to 14 had excellent electric generating performance.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A cell for a fuel cell comprising an electrolyte membrane, conductive porous members in a sheet shape or a plate shape which are laminated so as to sandwich the electrolyte membrane, and contains an ion catalyst at least the electrolyte membrane side, and separators in a sheet shape which are laminated so as to sandwich the electrolyte membrane and conductive porous members and comprises a supplying opening and a discharging opening for fluid,
wherein at least one of the conductive porous members is a conductive fiber-containing porous member comprising a binder resin and conductive fibers, and the conductive fiber-containing porous member comprises an orientation layer in which conductive fibers are orientated along a flow direction of the fluid.

2. A cell for a fuel cell according to claim 1, wherein the conductive fiber-containing porous member comprises a catalyst layer and a gas diffusion layer;
the catalyst layer is positioned at the electrolyte membrane side and contains an ion catalyst, conductive material, and a binder resin;
the gas diffusion layer is positioned at the separator side and contains conductive material; and
the gas diffusion layer comprises the orientation layer.

3. A cell for a fuel cell according to claim 1, wherein the conductive fiber-containing porous member comprises a catalyst layer and a gas diffusion layer;
the catalyst layer is positioned at the electrolyte membrane side and contains an ion catalyst, conductive material, and a binder resin;
the gas diffusion layer is positioned at the separator side and contains conductive material; and
the catalyst layer comprises the orientation layer.

4. A cell for a fuel cell according to claim 1, wherein the orientation layer contains an ion catalyst.

5. A cell for a fuel cell according to claim 1, wherein an aspect ratio of the conductive fibers contained in the orientation layer is in a range from 50 to 10,000.

6. A cell for a fuel cell according to claim 1, wherein the orientation layer further contains conductive material other than the conductive fibers, and a mass ratio (a/b) between an amount (a) of the other conductive fibers and the conductive material and an amount (b) of the binder resin in the orientation layer is in a range from 0.5 to 3.0.

7. A method for producing a cell for a fuel cell comprising forming conductive porous members in a sheet shape or a plate shape which contains an ion catalyst at least an electrolyte membrane side on both sides of the electrolyte membrane; and laminating separators in a sheet shape which comprises a fluid supplying opening and a discharging opening for fluid,
wherein at least one of the conductive porous members is a conductive fiber-containing porous member comprising a conductive fiber-containing layer which is obtained by using a conductive fiber-containing slurry comprising conductive fibers, a binder resin, and dispersing medium and orientating the conductive fibers in one direction, and laminating the separators on the conductive fiber-containing porous member such that the conductive fibers in the conductive fiber-containing layer are oriented along a flow direction of the fluid.

8. A polymer electrolyte fuel cell comprising the cell for a fuel cell according to claim 1.
